(19) United States
(12) Patent Application Publication
(10) Pub. No.: US 2008/0226437 A1
(43) Pub. Date: Sep. 18, 2008

(54) SYSTEM, METHOD AND APPARATUS FOR SPACE-EFFICIENT OBJECT STORAGE

(75) Inventor: Walter A. de Milly, Key West, FL (US)

Correspondence Address: LARSON AND LARSON, 11199 69TH STREET NORTH, LARGO, FL, 33773, US

(73) Assignee: PACKMAX IP HOLDINGS, LLC, Key West, FL (US)

(21) Appl. No.: 12/129,116

(22) Filed: May 29, 2008

Related U.S. Application Data
(63) Continuation-in-part of application No. 11/615,257, filed on Dec. 22, 2006.

(51) Int. Cl. B65G 1/133; B65G 57/09

(52) U.S. Cl. 414/790.9; 414/749.1; 414/749.6; 414/800

(57) ABSTRACT

An application for an efficient storage system includes objects held in containers or on frames. The objects are moveably organized within a building and organized in positions within a grid of rows and columns, each position large enough to hold the one of the objects. At least one empty position within the grid for shifting one of the objects from one position to another. At least one access location is provided for loading and unloading the objects and a mechanism is provided for moving the containers within the grid.

### CROSS-REFERENCE TO RELATED APPLICATIONS

This application is a continuation of non-provisional application titled “SYSTEM, METHOD AND APPARATUS FOR SPACE-EFFICIENT CONTAINER STORAGE,” Ser. No. 11/615,257 filed Dec. 22, 2006. The entire contents of all the above application is hereby incorporated by reference.

### BACKGROUND OF THE INVENTION

1. Field of the Invention

This invention relates to the field of container storage and more particularly to a system storage and retrieval of objects that efficiently utilizes space.

2. Description of the Related Art

Many storage systems have been devised to store and retrieve goods, usually in container or on palettes or objects such as vehicles, drums, etc. The simplest of such systems consists of storage bins, one deep, situated along aisle ways that are wide enough for a fork lift to maneuver and access objects such as containers or palettes located in the bins. Even if a forklift is capable of turning within its own radius, the forklift requires room to maneuver as well as sufficient space for its own ingress and egress. Because the fork lift must turn to access and remove the container/palette, the aisle must be wider than the container/palette is deep. Therefore, in this configuration, more floor space is consumed by aisle ways than by storage bins. Some improvement to this storage system's efficiency can be derived from having more than one level of storage, but this is limited to the height of access for a fork lift.

One improvement to this lack of efficiency is proposed in U.S. Pat. Application No. 2004/0165974 to Gironi, et al. In this, a three dimensional array of storage bins are accessible by a “trans-elevator” that traverses aisle between stacked storage locations. Although this device permits a greater number of stacked cartons, it still has the inefficiency of aisles.

Another solution is proposed in U.S. Pat. Application No. 2004/0146380 to Baker, et al. In this, a system of conveyors pass through aisles formed between storage locations. Although this device permits a greater number of storage locations, it still has the inefficiency of aisles.

U.S. Pat. No. 3,730,358 to Oji has a random storage system that uses an overhead crane to shuffle containers until the desired container is accessible. This system requires extra storage space for all containers that need be moved while accessing the container below, spacing between the containers for crane access and headroom for the overhead crane system and therefore doesn't utilize space efficiently.

U.S. Pat. No. 3,622,020 to Sarvary has a mechanized palette storage system that uses elevators and trucks. This system has aisle ways and therefore doesn't utilize space efficiently.

What is needed is a system that will store objects in a space-efficient manner while providing random access to any such objects.

### SUMMARY OF THE INVENTION

In one embodiment, an efficient storage system is disclosed including a plurality of objects moveably organized within a building that organized as a grid of storage positions in rows and columns, each storage position size to hold at least one of the objects. At least one empty storage position within the grid allows for shifting of the objects within the grid. At least one access location is provided to access the objects and a mechanism is provided for moving the objects within the grid.

In another embodiment, a method of efficiently storing objects is disclosed. The objects are held in or on frames. The method includes organizing the frames within a building on a grid. The frames are movable from one storage location within the grid to a neighboring storage location within the grid and there is at least one empty storage location within the grid. A target frame is selected (e.g., the frame containing an object of which access is desired) and the frames within the grid are sequentially shifted until the target frame reaches an access location.

In another embodiment, an efficient storage system is disclosed including a plurality of storage objects organized in a grid of equal sized positions. The grid is organized in rows and columns; each position of the grid is sized to hold one of the storage objects. There is at least one more position than storage objects, allowing for shifting of the storage objects. At least one access location is provided for loading and unloading the storage objects. The storage objects are mechanically moved within the grid.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an isometric view of a system of a first embodiment of the present invention.

FIG. 2 illustrates another isometric view of a system of a first embodiment of the present invention.

FIG. 3 illustrates a detail isometric view of a booster of a first embodiment of the present invention.

FIG. 4 illustrates a side view of a container of the present invention.

FIG. 5 illustrates a bottom view of a container of some embodiments of the present invention.

FIG. 6 illustrates an isometric view of the present invention with multiple levels of containers.

FIG. 7 illustrates an isometric view of the present invention with multiple levels of containers and a lift for accessing a second or third level container.

FIG. 8 illustrates an isometric view of the present invention with multiple levels of containers and an elevator for accessing a second or third level container.

FIG. 9 illustrates an isometric view of the present invention with multiple levels of containers and an elevator positioned for accessing a second or third level container.

FIGS. 10-19 illustrate access of a container in a 9-container grid having one empty space.

FIGS. 20-31 illustrate access of a container in a 16-container grid having two empty spaces.

FIG. 32 illustrates a typical computer control system of the present invention.

FIG. 33 illustrates an isometric view of the present invention with framed containers.

FIG. 34 illustrates an isometric view of the present invention with framed containers and stands.

FIG. 35 illustrates an isometric view of the present invention with framed containers holding various objects.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. The term container represents any storage unit that holds goods or other materials (e.g., nuclear rods, Petri dishes, etc). The container can be of any size depending upon the types of goods being stored. One example of such a container is the moving containers that some companies deliver to a customer's site for loading, and then retrieve them after loaded. Another example is the cargo containers used for shipping between countries, whereby the container is roughly the size of a tractor trailer and can be stacked onboard a ship for overseas shipment, then lifted off the ship and placed upon a flatbed truck for final delivery to a destination. Containers don't have to be large. Small containers are more practical for assembly components such as screws, washers, electronic components, etc. In all of the following, for simplicity, the description will refer to containers, though, palettes, frames or any other monolithic storage unit is fully interchangeable with container. For example, the present invention is useful for storing soda cans, whereby each can is one unit of storage and is manipulated just as a container is manipulated. The frames are any open storage conveyor that is moved within the grid. The frames are any open storage conveyor that is moved within the grid. For example, in one embodiment, the frames are flat structures with two or three sides for supporting subsequent frames while in another embodiment, the frames (or pans) are flat structures with no sides capable of supporting objects, objects on palettes or stacks of objects on palettes. In all embodiments, the frames, pans, flats, containers, etc., include provisions, as needed, for traveling within the grid such as wheels, pins, registration holes, channels, rails, etc.

Although, in this description, the present invention is shown within a building structure, the present invention is anticipated to be integrated into other structures such as transportation structures like the storage hold of cargo ships, cruise liners, airplanes, trucks, etc., whereas it is desirable to efficiently utilize all (almost all) available space while providing for random access of objects stored within the space when the transportation structure makes intermediate stops. For example, in an airplane flying from New York to Los Angeles stopping in Chicago and Phoenix, it would not be necessary to load the Los Angeles luggage first, then the Phoenix Luggage, then the Chicago luggage.

Although shown as equal sized containers or frames, the present invention anticipates and includes embodiments having multiple container sizes. For example, a system can have 4′×12′×8′ containers mixed with 4′×6′×8′ containers, whereby two 4′×6′×8′ containers occupy the space of one 4′×12′×8′ container, etc.

Generally, there are locations in the world such as Japan, Florida and parts of California where the price of land or building floor space is very expensive. As a result, there have been attempts to efficiently utilize as much space as possible. For example, in Japan, parking lots have stacked parking spaces whereby a car elevator lifts the car to the second level.

For storage of containers, palettes or frames, it would be ideal to completely occupy the entire floor of a building with containers palettes or frames, thereby wasting little or no space. Furthermore, if a building is of open construction with a single floor, it would be ideal to utilize the maximum cubic space of that floor. If every container had the same content, this could be done, but most storage operations include containers of varying content. One example of such an operation is self-storage. In this, individuals are usually assigned a storage location and when they need to store or retrieve something from their storage location, they go to the location, open a door and access the contents. This system requires wide aisles between rows of storage locations for the customer to drive to their designated storage location. If, instead, the goods are stored in containers, the containers can be delivered to the customer when they require access, permitting more efficient storage of the containers. As described previously, prior attempts to provide container storage access all required aisles or wasted space. Such containers could not be stored by filling a building from the front to the back, because as soon as you fill the building, the customer with the storage container in the back will want access and all other containers in front of theirs will have to be relocated.

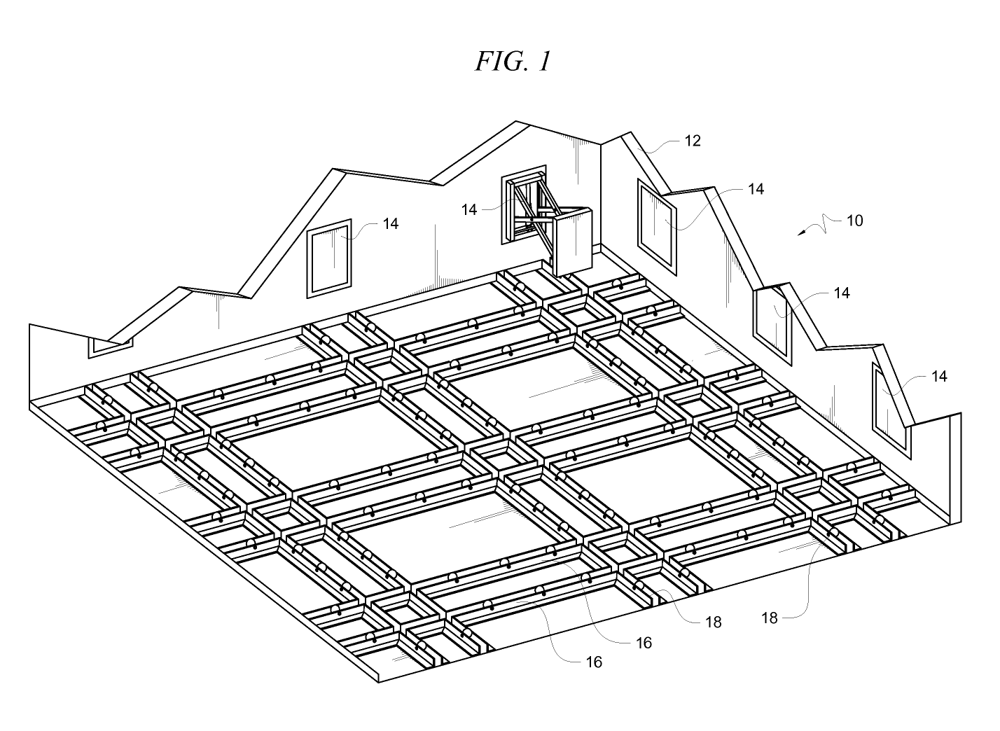

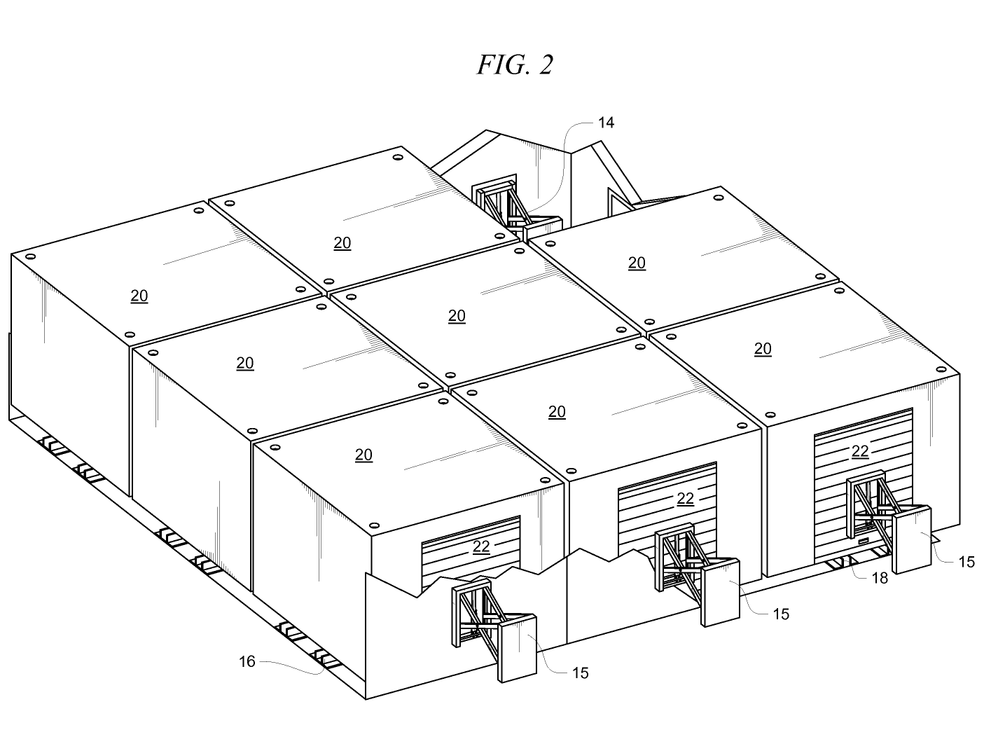

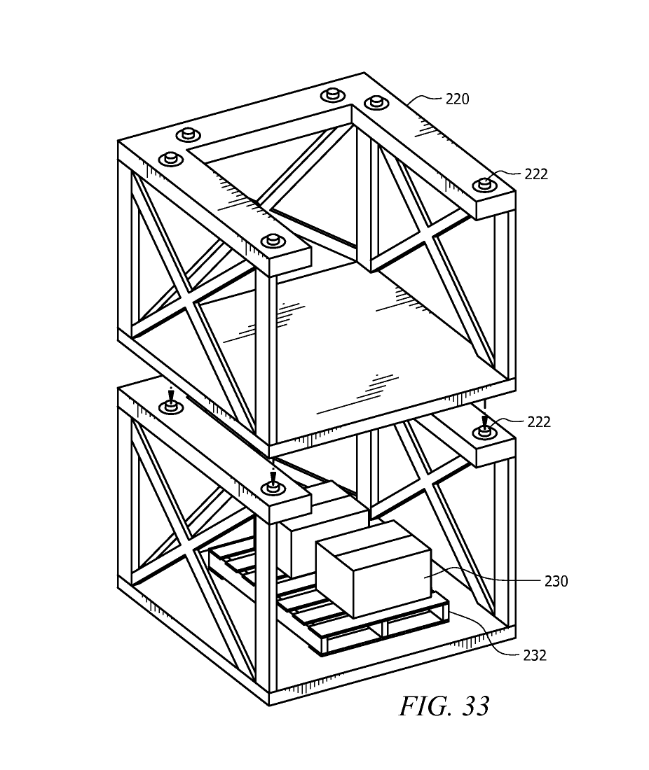

Referring to FIG. 1, an isometric view of a system of a first embodiment of the present invention will be described. In this example, a building 10 is configured to hold up to nine containers 20 (see FIG. 2) or stacks of containers in rows of three (X direction) and columns of three (Y direction), forming a grid. In the following description, the term container is used although any object or combination of objects is anticipated in place of the container as exemplified in FIGS. 33-35 and the associated descriptions.

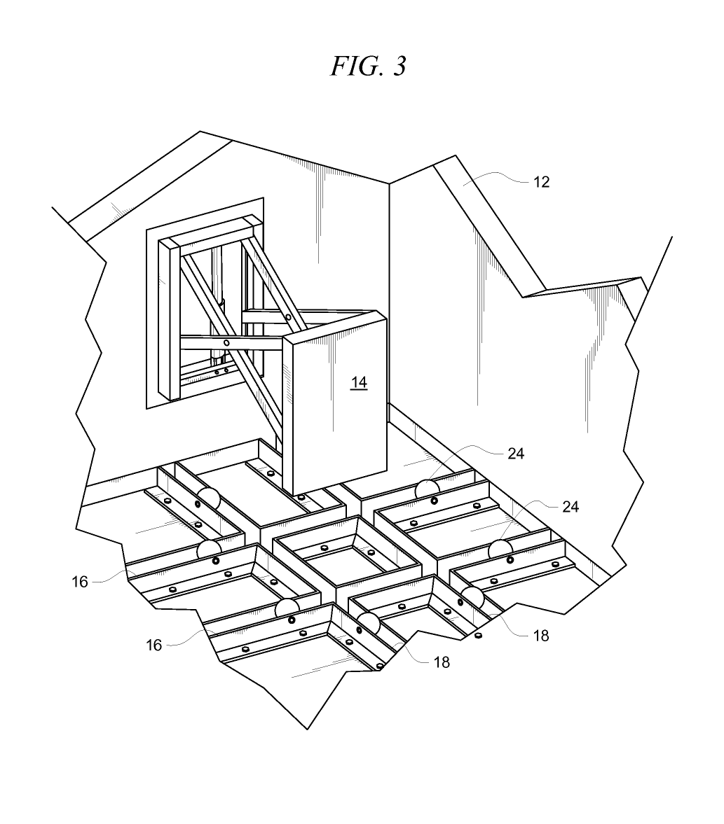

The containers move parallel to the walls 12 of the building on balls 24 in sockets 25 (see FIG. 3) mounted to rails 16/18. Although shown using a rail support system and ball and eye sockets 24, any type of slidable interface works equally as well. For example, in one embodiment, the containers, palettes or frames are coated with a slippery bottom surface and the floor of the building 10 another slippery surface to permit migration of the containers, palettes or frames from position to position. In another embodiment (not shown), wheels are retractably mounted in the rail system such that wheels in the first rails 16 going in the X direction are retracted when the cartons are moved in the Y direction along the extended wheels of the rails 18 at right angles to the first rails 16.

In the embodiment shown, scissor jacks 14 are positioned at the ends of every row and column to move the containers. For a three by three configuration as shown in FIG. 1, nine scissor jacks 14 are used. The scissor jacks 14 push the containers 20 into a position that is vacant as will be described later. In this way, by multiple successive shifts using the scissor jacks 14, a container 20 that was inaccessible is shifted until it is in a position whereby it is accessible, as will be shown. Although shown using scissor jacks 14 for simplicity, many other methods of moving the containers 20 are possible including, but not limited to, a chain and gear system in each rail, a hydraulic piston at the end of each row and column, motorized containers, motorized guided vehicles traveling beneath the object (frame, container, etc.) and a wheel coupled to a motor under each X-Y position. Furthermore, in some embodiments, the movement mechanism is capable of moving the containers in two directions, thereby eliminating the need for a movement mechanism such as the scissor jacks 14 at both ends of each row/column. In the embodiment shown, the scissor jacks 14 must latch onto the containers 20 in order to pull them back and the containers 20 must also selectively latch onto the next container 20 in the row/column so that the entire row/column can be pulled back together. In another embodiment (not shown), guided vehicles which travel on an x-y axis beneath the containers. In this embodiment, the containers 20 rest on a grid pattern of supports (e.g., pillars made from, for example, cinderblocks). Guided vehicles travel under the containers 20 and between the supports until such time as they reach a container 20 (or stack of containers 20) which requires movement. The guided vehicles are equipped with a lift mechanism so that the stack can be lifted above the support grid and then moved along the x or y axis. In some embodiments, the guided vehicles convey the container(s) 20 to another lift mechanism, which will then accept the stack of containers 20 from the guided vehicles. The guided vehicles are preferably powered by batteries that are recharged at designated stations along the perimeter of the grid and are controlled by a computer system 100. To increase efficiency and thereby decrease access time, multiple guided vehicles are deployed as well as additional empty grid locations. If any one such vehicle fails, access to any container 20 can still be achieved by the other vehicles.

Referring to FIG. 2, another isometric view of a system of a first embodiment of the present invention will be described. In this simplified example, eight containers 20 are positioned in the nine positions on a grid, leaving one empty position. Each container 20 has an access door 22. The containers 20 move freely within the grid on the rails 16/18 and ball 24 and sockets 25. In the exemplary configuration, the front three containers 20 are at access locations and are thereby, accessible through their doors 22. Conversely, the other five are not currently accessible because their doors 22 are blocked by other containers. In this example with 9 storage positions, the total storage space occupation is 8/9 or 89%. If the same space was allocated such that no containers 20 had blocked doors 22, then an access row would be required, wide enough to load/unload each container 20. Assuming such an access row is roughly the width of a container 20, only six storage containers would be possible, therefore the storage space occupation would have been 6/9 or 67%. It can be seen that as the number of containers 20 increase, the storage efficiency grows. For example 100 containers 20 in a 10 by 10 grid with one space yields a total storage space occupation of 99/100 or 99%.

FIG. 3, a detail isometric view of a booster of a first embodiment of the present invention will be described. In this example, the booster is a scissor jack 14 mounted to the building wall 12 and adapted to push a row of containers 20 along balls 24 in sockets 25 that are mounted to rails 16/18 or other structural support.

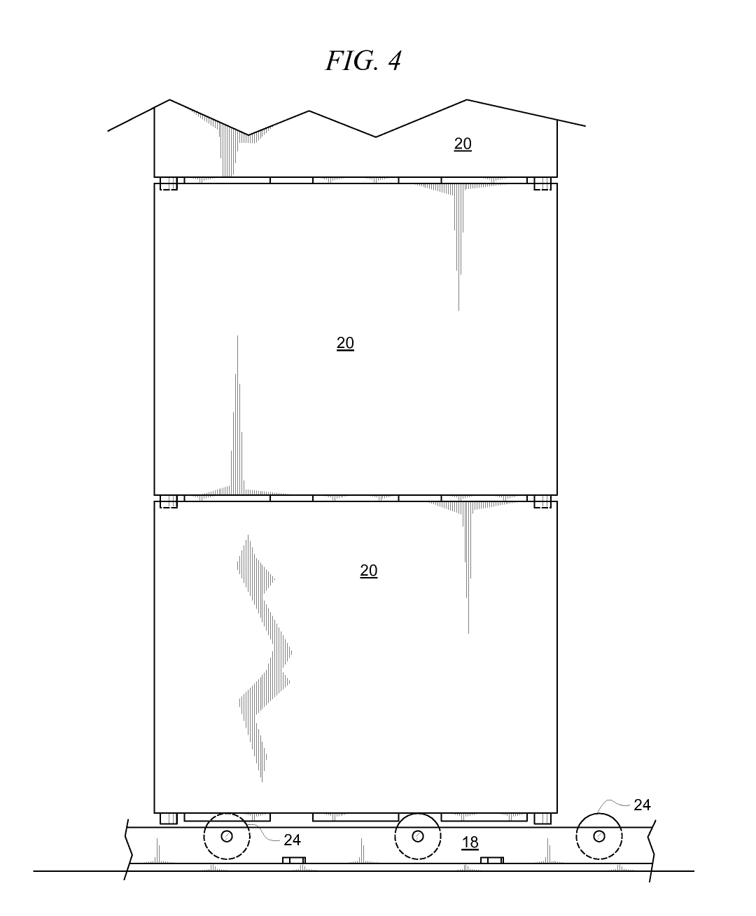

FIG. 4, a side view of one possible container of the present invention will be described. In this view, multiple containers 20 are stacked to further increase storage efficiency. In this example, only the X-rail 18 and ball 24 and sockets 25 are visible. By stacking the containers, the storage efficiency increases without significant increases in access time (as discussed later). For example, in a storage area of 4 rows and 4 columns of containers with one empty space, the efficiency is 15 spaces occupied divided by the total possible spaces which is 16, or 15/16, or around 94%. Stacking doesn't change this equation because stacking three high would result in 45/48 or, the same approximately 94%. What it affects is the total amount of storage with respect to floor space. For example, if a building is 16,000 square feet and each container is 100 square feet, then, without stacking, 15 containers and one space are possible—the 94% efficiency stated above. Given the same 16,000 square feet, by stacking three high, 45 containers occupy the same space, thereby tripling the amount of storage. This is critical when land prices are high or local ordinances allow only a certain percentage of land to be used for buildings, or when an existing building is used and it has sufficient clearance for multiple layers of stacked containers 20, etc. Note that, in some embodiments, the tops of the containers 20 have registration devices that mate with matching registration devices on the bottoms of containers 20 stacked above them. It is preferred that the registration devices include a male portion on the tops of the containers 20 and a female portion on the bottoms, thereby not interfering with the movement of the containers 20 within the grid.

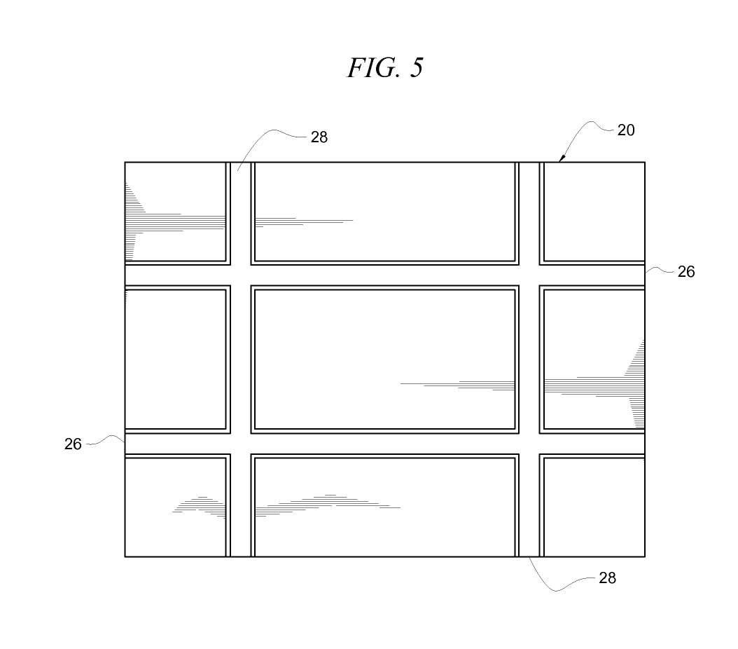

FIG. 5, a bottom view of a container of some embodiments of the present invention will be described. In these embodiments, the bottom of the container 20 has grooves 26/28 in which the balls 24 of the ball/socket 24/25 travel, thereby keeping the containers 20 positioned as they travel in the X-direction (grooves 26) and Y-direction (grooves 28). Any mechanism that keeps the containers 20 from shifting is acceptable so long as the containers 20 don't shift slightly into an empty space and block the shifting of other containers 20. For example, in the embodiment using wheels that retract, channels mounted to the bottom of the containers 20 in place of the grooves 26/28 provide guides, keeping the containers 20 in their proper grid position. Note, other methods of moving containers are known and the present invention is not limited in any way to the described method of moving containers with or without bottom registrations and with or without male/female stacking alignment guides.

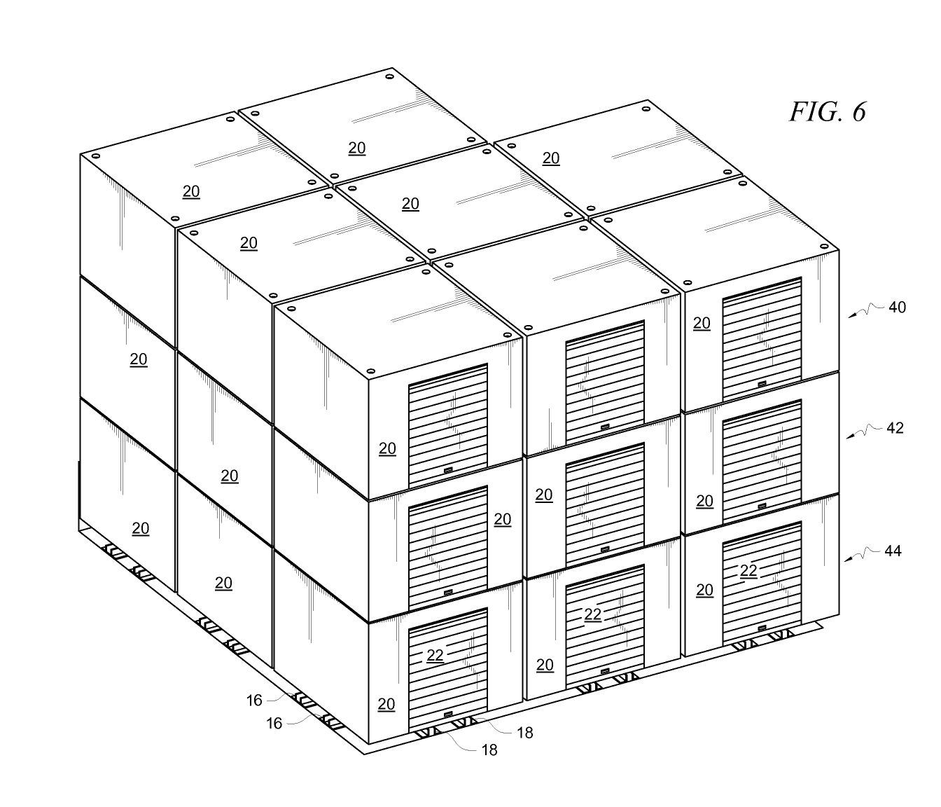

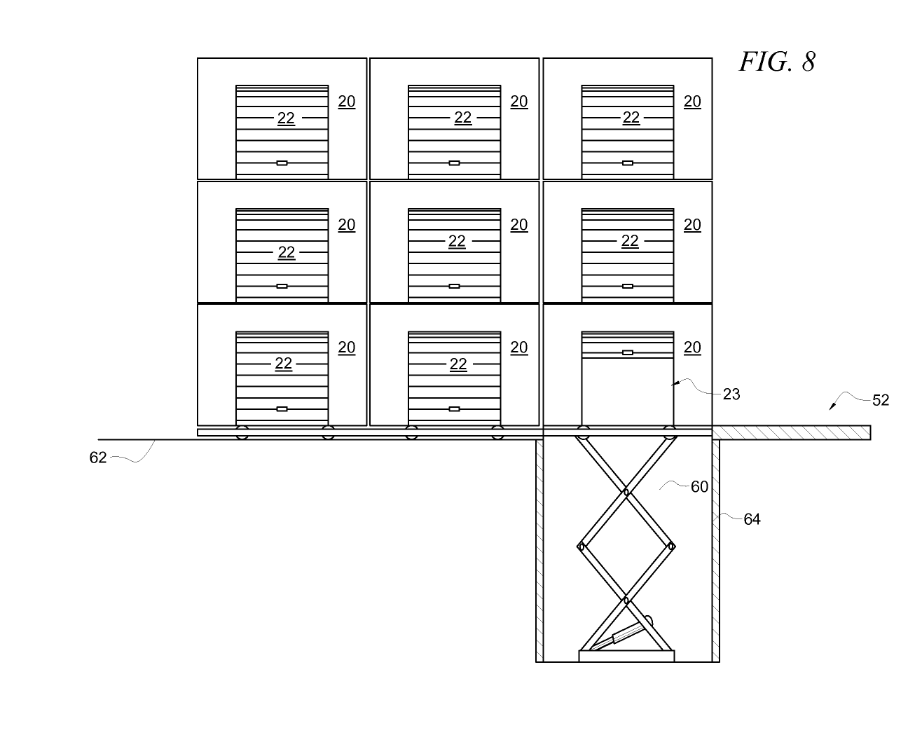

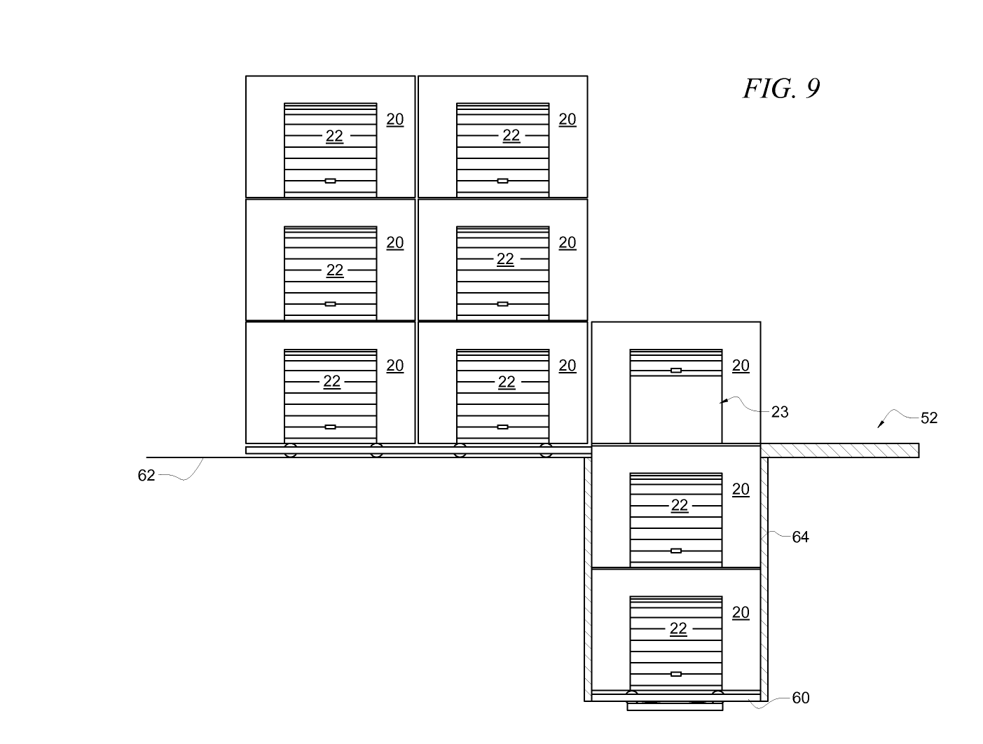

FIG. 6, an isometric view of the present invention with multiple levels of containers will be described. This figure shows a configuration of three rows or three columns of containers 20 stacked three high in three levels 40/42/44, allowing for the storage of 24 containers. FIGS. 8 and 9 will show exemplary ways to access the upper containers. The slidable mechanism must be structurally sound to hold the weight of three containers high along with their contents.

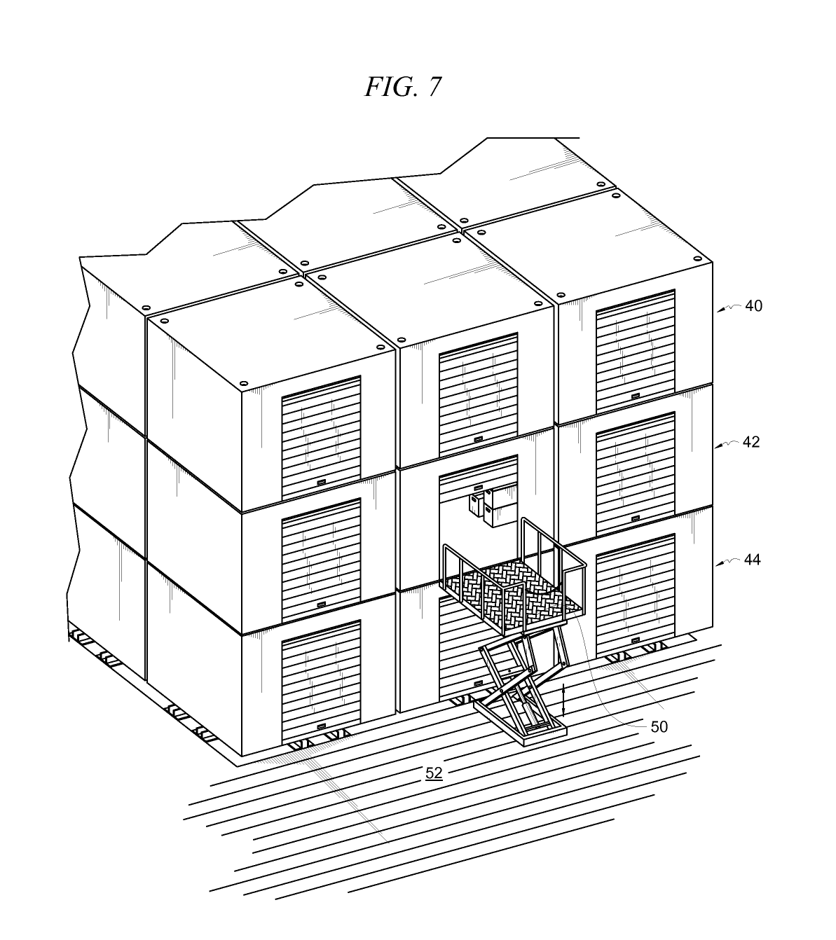

FIG. 7, an isometric view of the present invention with multiple levels of containers and a lift for accessing a second or third level container will be described. In this embodiment, the desired containers 20 are shifted until the access door 22 is facing forward at an access location. A lift 50 is provided to elevate one or more people to the upper level containers 20 at either the middle level 42 (as shown) or upper level 44. There are many lifts possible. In alternate embodiments, a fork lift type of device is used to lift the upper containers 20 from the 2^{nd} stack 42 or 3^{rd} stack 44 and place them on the ground 52 for loading and unloading.

FIG. 8, an isometric view of the present invention with multiple levels of containers and an elevator for accessing a second or third level container will be described. In this embodiment, an elevator 60 is adapted beneath one stack 65 of containers 20. The elevator 60 is in a small basement 64 that is deep enough to hold the elevator mechanism 60 and all but one container 20 in the stack 65 of containers 20 above the elevator 60. As shown in FIG. 8, the container 20 at the bottom 40 of the stack 65 is at ground level 52 and opens 23 for loading and unloading. The rails 16/18 rest on the building foundation 62.

FIG. 9, an isometric view of the present invention with multiple levels of containers and an elevator positioned for accessing a second or third level container is shown. In this configuration of the embodiment, the elevator 60 has lowered the lower two containers 20 in the stack 65 above the elevator into the small basement 64. The container 20 at the top 44 of the stack 65 is now at ground level 52 and opens 23 for loading and unloading. The stack 65 of containers 20 must be raised level with the other stacks before further shifting is performed.

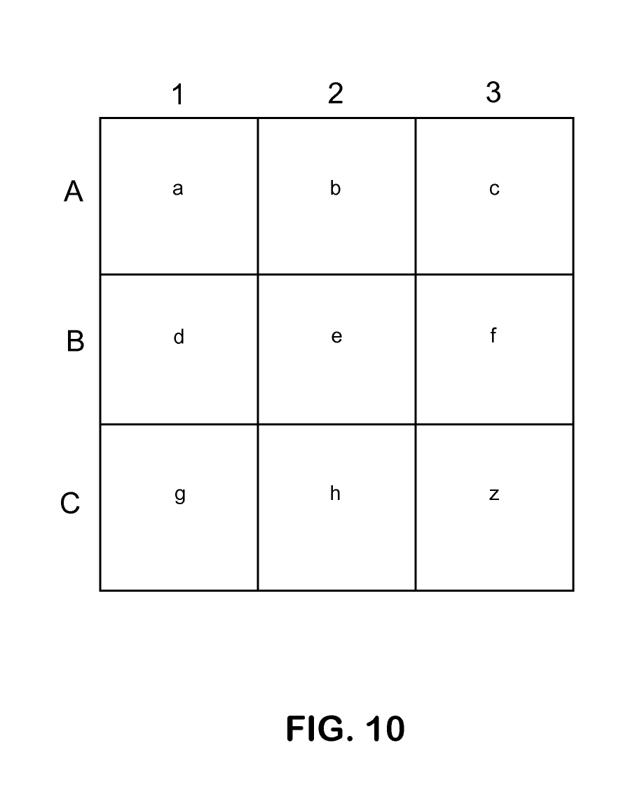

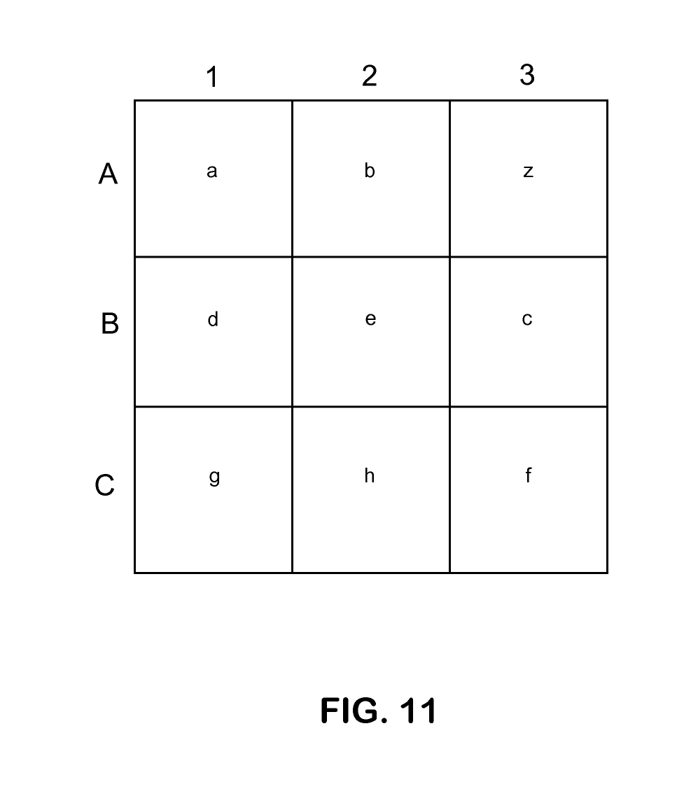

Referring now to FIGS. 10-31, the method of accessing of a particular container will be shown. In this example, there are nine positions (a-h, z) having containers in eight positions (a-h) and one empty position (z). In this example, each position is denoted by a row and column letter/number. For example, the container marked “a” is in the A1 position and the container marked “b” is in the A2 position. In the example shown, it is desired to access the contents of container b and the access door is at the position C3. To access b, c,f are shifted down from {A3,B3} to {B3,C3} resulting in z (empty position) moving to A3 as shown in FIG. 11.

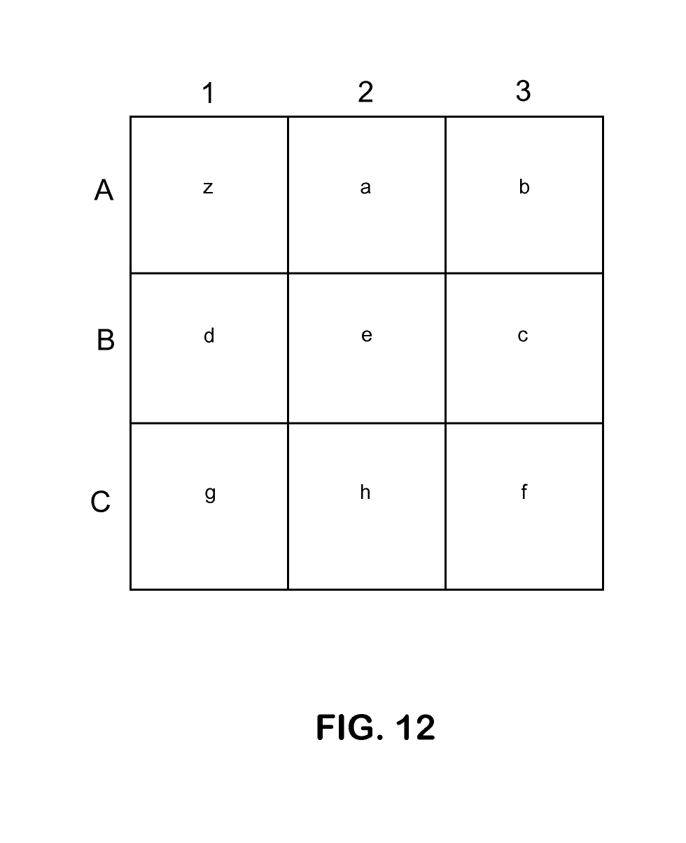

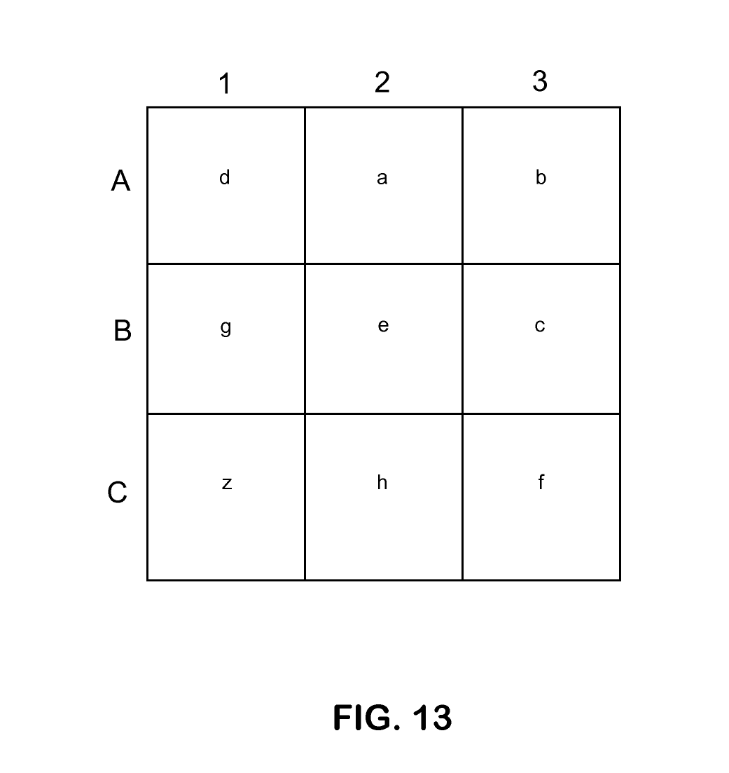

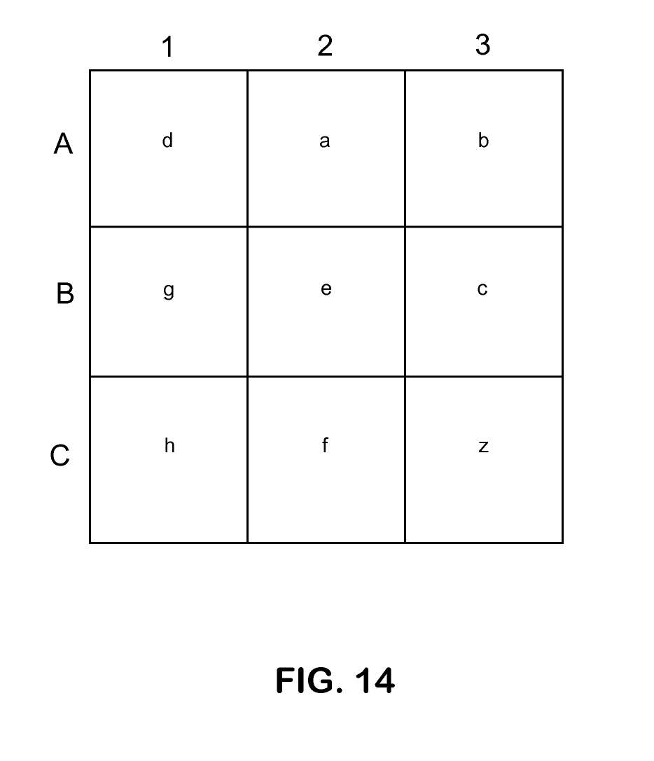

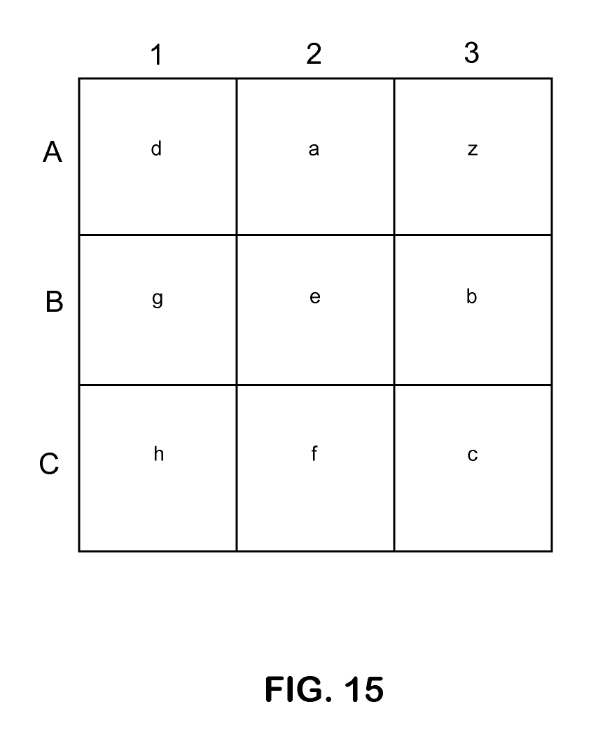

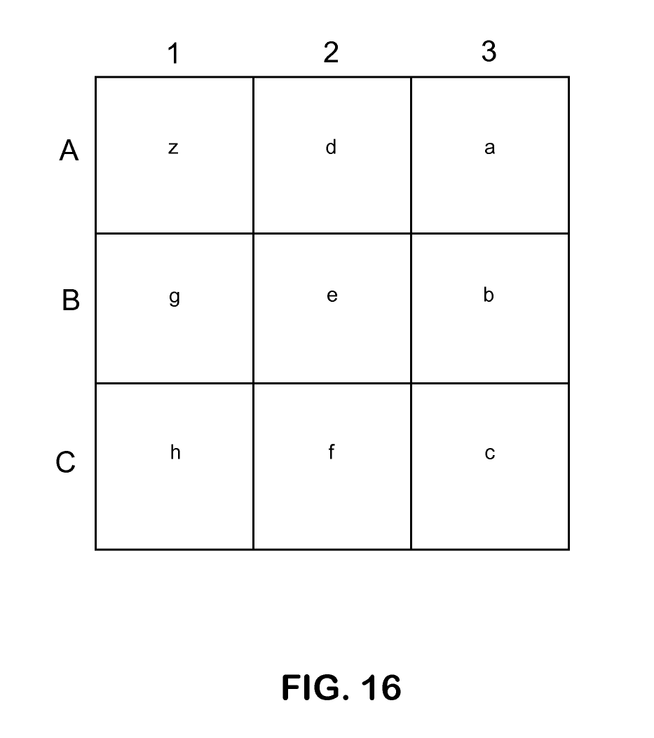

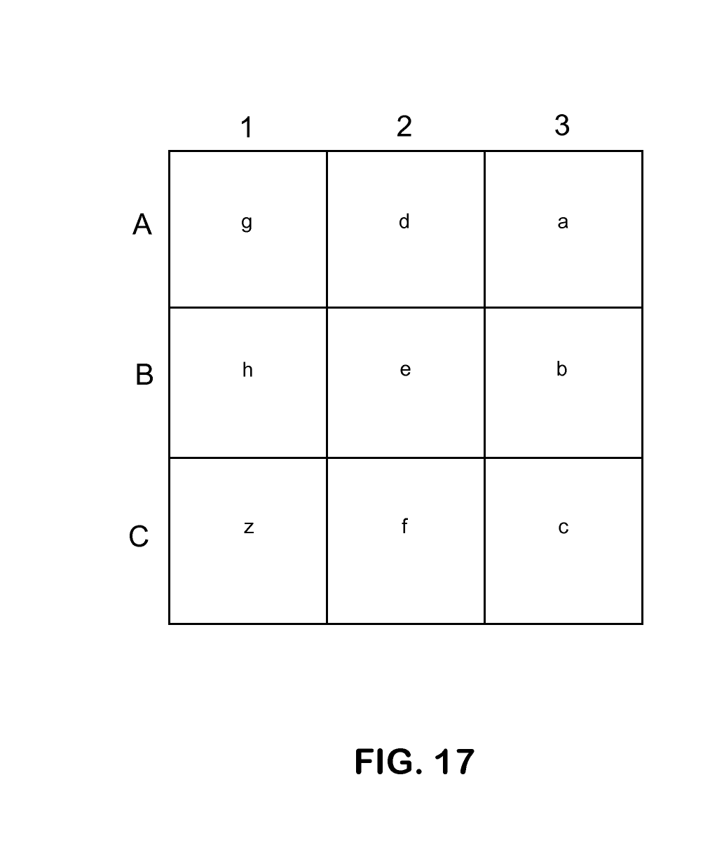

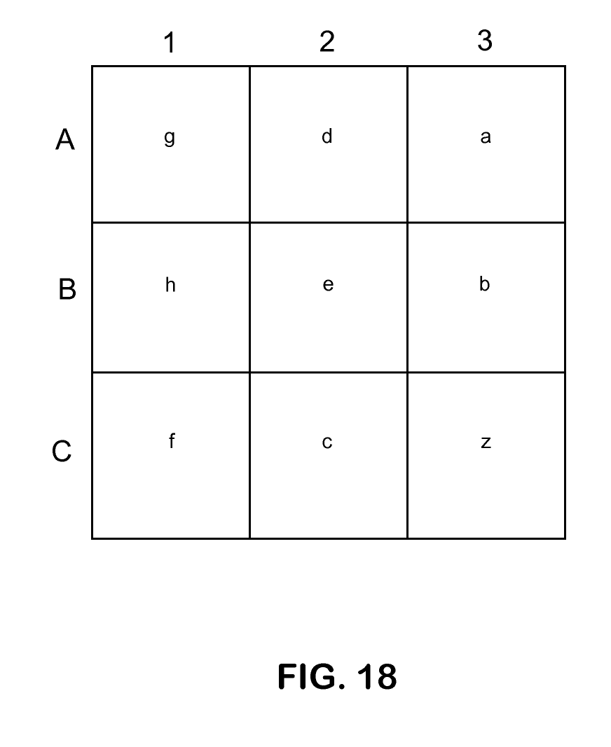

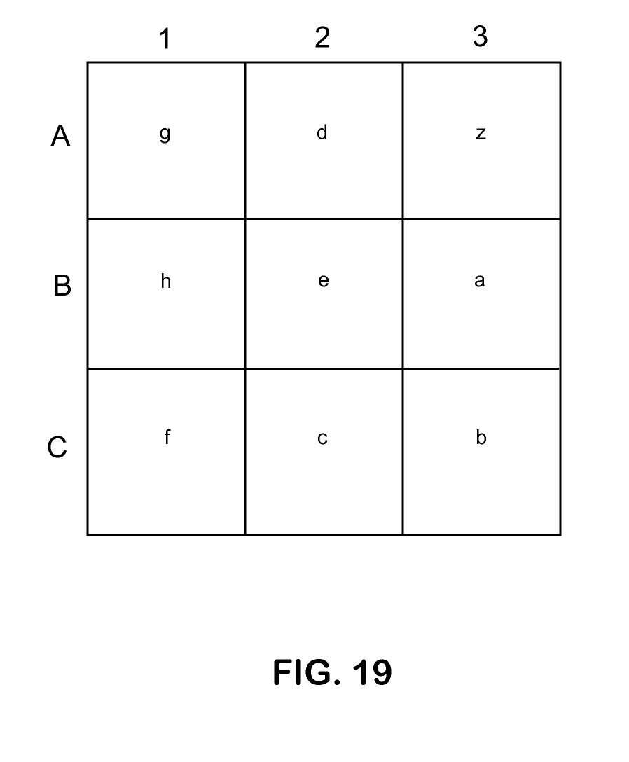

Next, in FIG. 12, a,b are shifted right and the empty space is at A1. In FIG. 13, d,g, are shifted up and the space is in C1. In FIG. 14, h,f are shifted left and the space is in C3. In FIG. 15, b,c are shifted down and the space is in A3 In FIG. 16, d,a are shifted right and the space is in A1. In FIG. 17, g,h are shifted up and the space is in C1. In FIG. 18, f,c are shifted left and the space is in C3. In FIG. 19, a,b are shifted down and the space is in A3. At this point, b is now in A3 where the access door of this example resides and the contents of b are accessible.

Another way to represent this sequence is shown in Table-1 below:

TABLE 1

| A1 | A2 | A3 | B1 | B2 | B3 | C1 | C2 | C3 | |
|---|---|---|---|---|---|---|---|---|---|
| a | b | c | d | e | f | g | h | | Initial state |
| a | b | | d | e | c | g | h | f | First shift |
| | a | b | d | e | c | g | h | f | Second shift |
| d | a | b | g | e | c | | h | f | Third shift |
| d | a | b | g | e | c | h | f | | Fourth shift |
| d | a | | g | e | b | h | f | c | Fifth shift |
| | d | a | g | e | b | h | f | c | Sixth shift |
| g | d | a | h | e | b | | f | c | Seventh shift |
| g | d | a | h | e | b | f | c | | Eighth shift |
| g | d | | h | e | a | f | c | b | Ninth shift |

In this sequence, 9 shift operations are required to move the container, “b” from the A2 position to the C3 position. If container “a” was desired, instead, the additional shifts shown in Table-2 would be required:

TABLE 2

| A1 | A2 | A3 | B1 | B2 | B3 | C1 | C2 | C3 | |
|---|---|---|---|---|---|---|---|---|---|
| g | d | | h | e | a | f | c | b | From Table-1 |
| | g | d | h | e | a | f | c | b | 10^{th} shift |
| h | g | d | f | e | a | | c | b | 11^{th} shift |
| h | g | d | f | e | a | c | b | | 12^{th} shift |
| h | g | | f | e | d | c | b | a | 13th shift |

This sequence requires four additional shifts for a total of 13 shifts, this being the longest sequence for a 3 by 3 matrix. A four by four matrix would require 25 shift operations to move the furthest container to the access door, while a five by five matrix would require 32 shift operations for the worst case.

Basically, to move a given container one position requires four shift operations. Therefore, if the matrix is three by five (A1 . . . C5), eight (2*4) shift operations are required to move from the A1 to the C1 position and sixteen (4*4) shift operations are required to move from the Cl position to the C5 position. This can be represented mathematically as:

4*(X−1)+4*(Y−1)−3,

where X is the number of positions in the X direction or columns and Y is the number of positions in the Y direction or rows. Three is subtracted because on the last shift operation, the designated container is in position on the first shift.

For a ten by ten matrix, 4*(10−1)+4*(10−1)−3 (69) shift operations are required to access the most distant container, while if you assume a random access pattern, the average number of shifts to access a random container 20 within this matrix would be one half of that, or approximately 34 shift operations. These calculations assume only one access position located at a corner. Further improvements are possible by having multiple access position and centrally located access position.

It can be seen that, given a configuration as previously described, having multiple access locations will improve access time because the average number of shifts from any random location to any of the multiple access locations will be less than the average number of shifts from any random location to a single access position. In this configuration, once the desired container 20 is positioned at one of the access locations, it can be accessed for loading and unloading, but if another user wants access to another container 20, they will have to wait until the first user is finished, in that an shifting to access the second user's container 20 will move the first user's container 20, unless, by luck, the second user's container 20 is already located at a second access locations This situation is addressed in embodiments having multiple empty positions such that the other containers 20 are rotated using the additional empty spaces while the first container 20 remains in its static position.

Being that shift operations may require a substantial amount of time, various alternate embodiments are anticipated. The simplest alternative is to schedule access to each container. For example, a customer can request access to their container at a specific time of day, either by making an appointment by phone or over the internet.

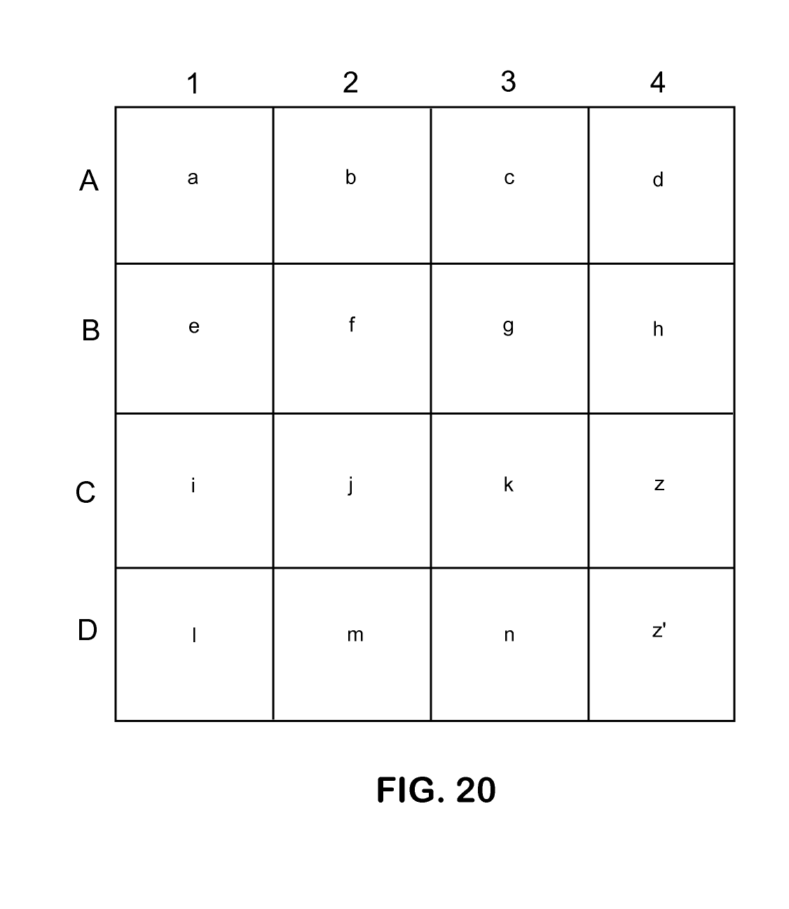

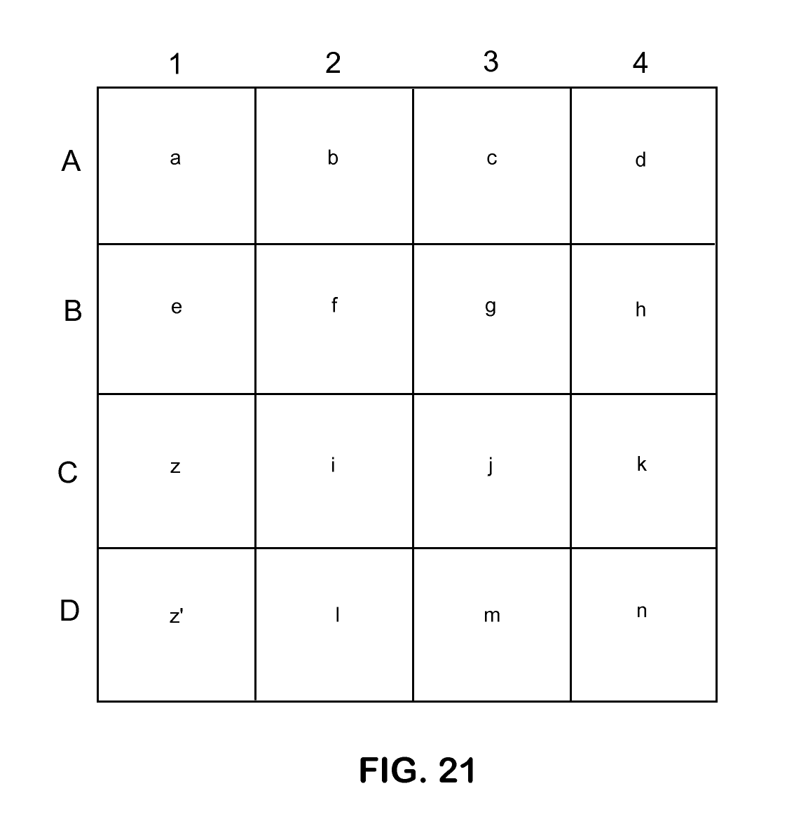

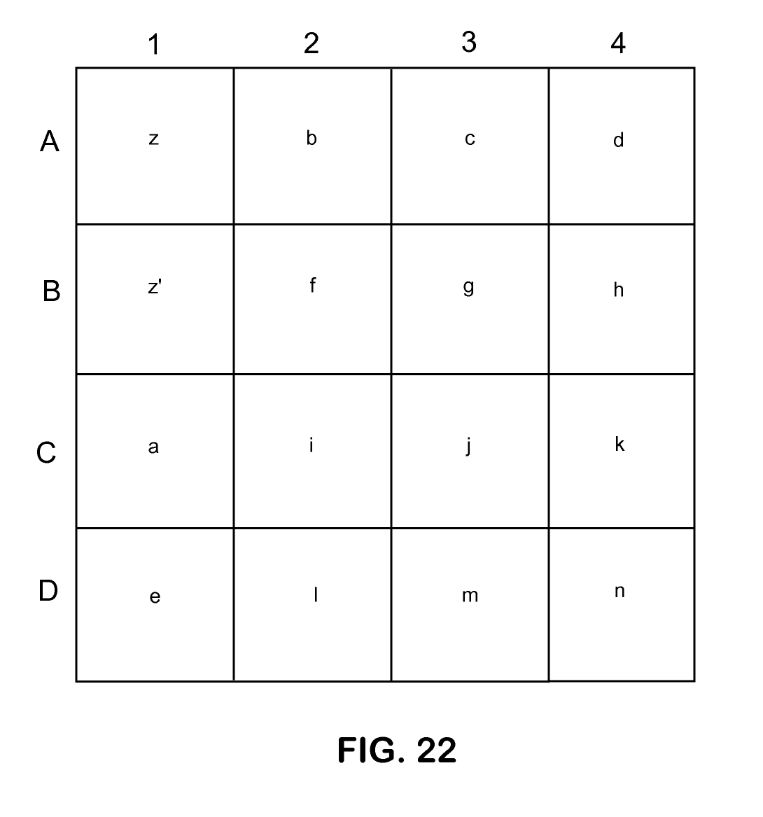

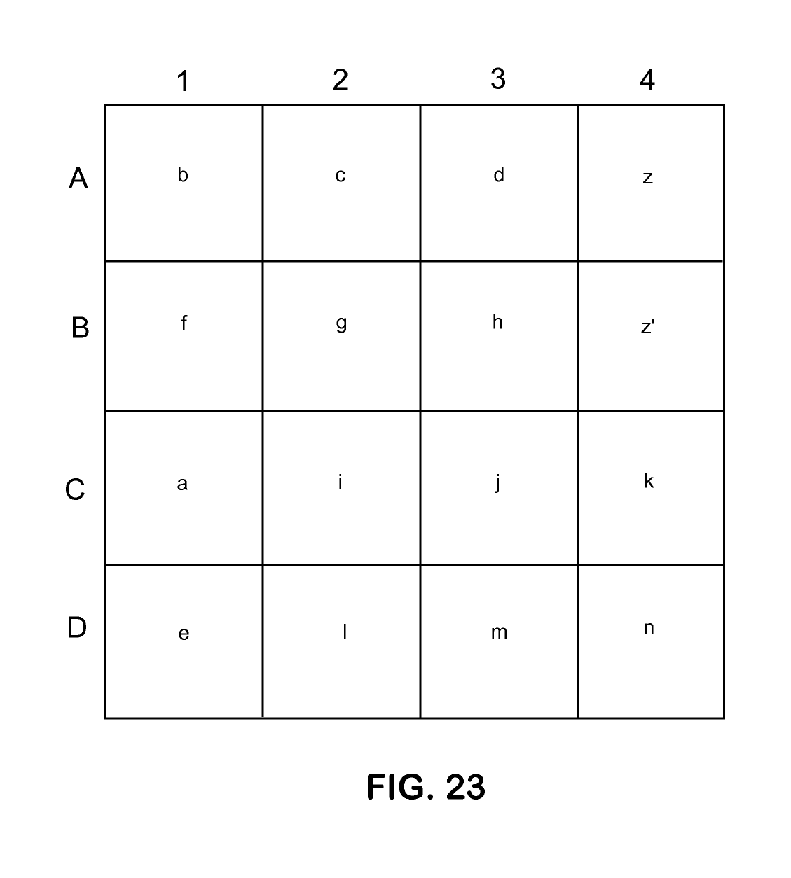

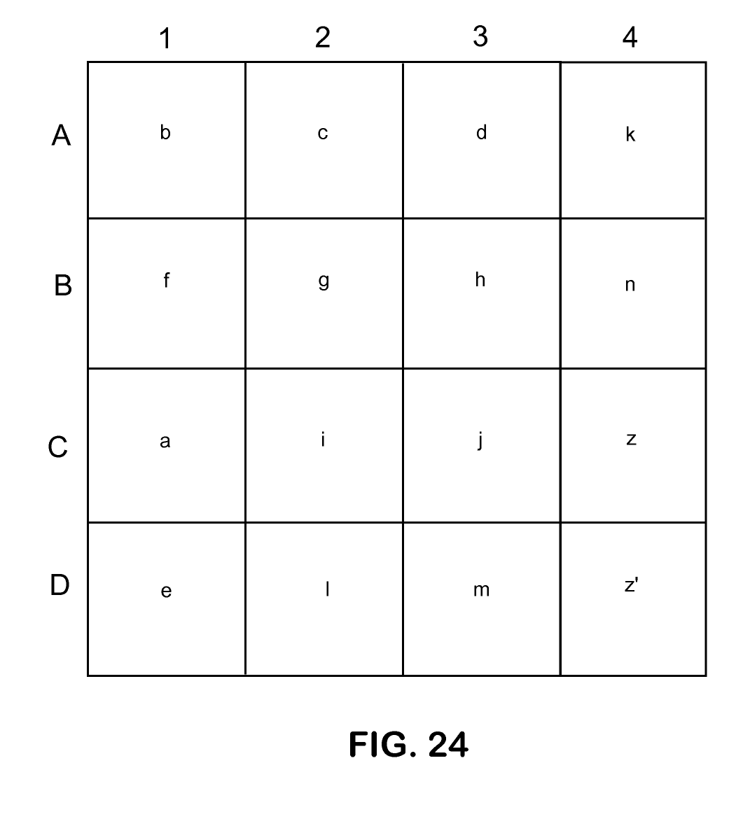

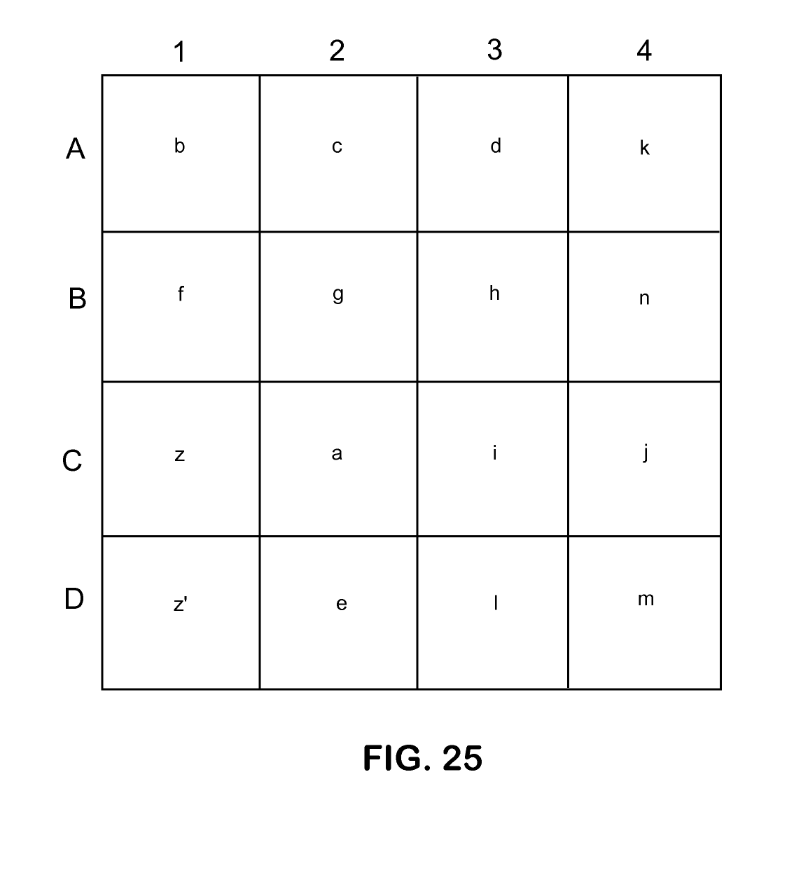

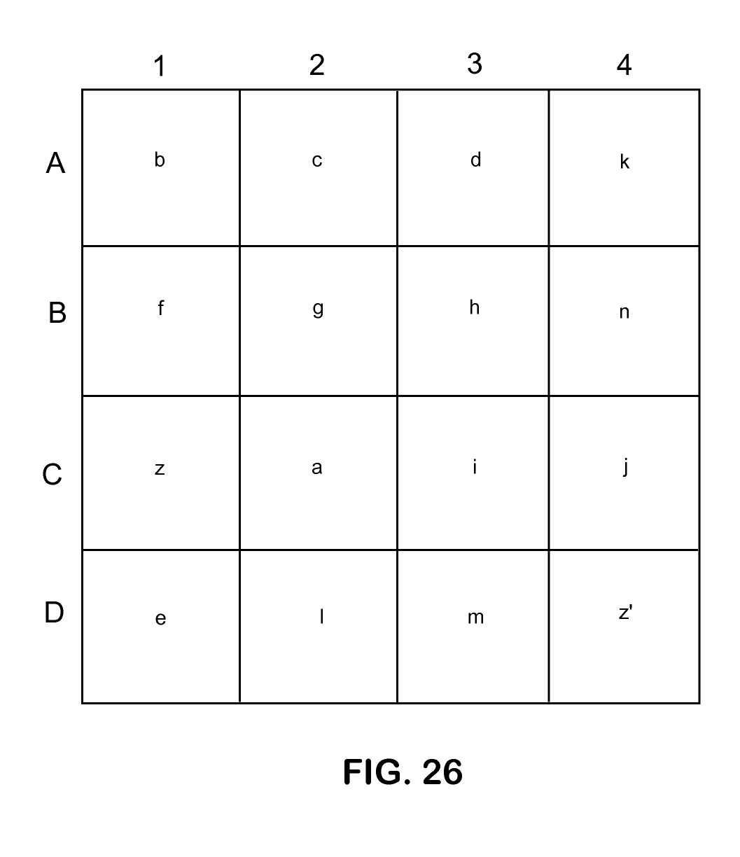

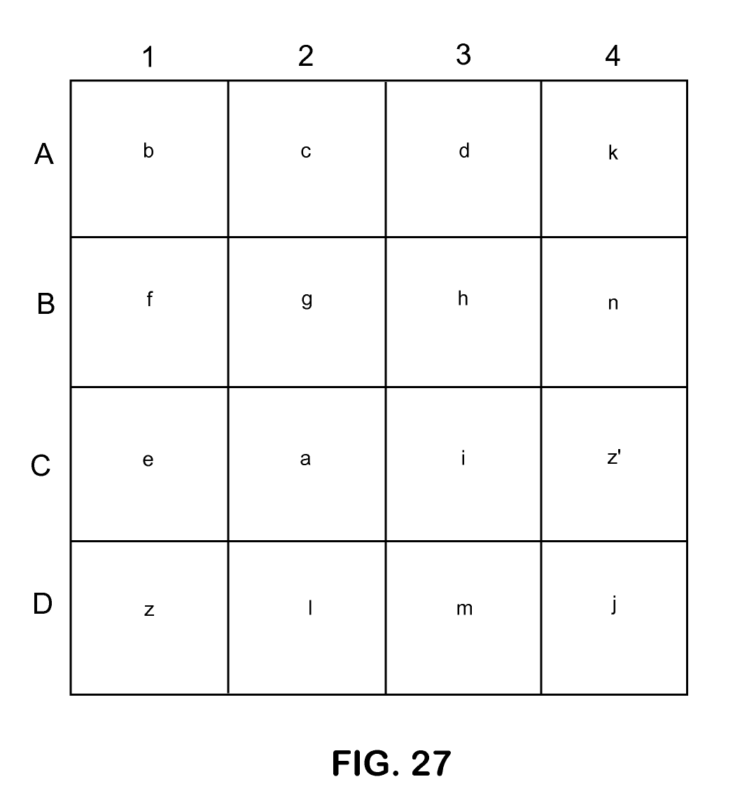

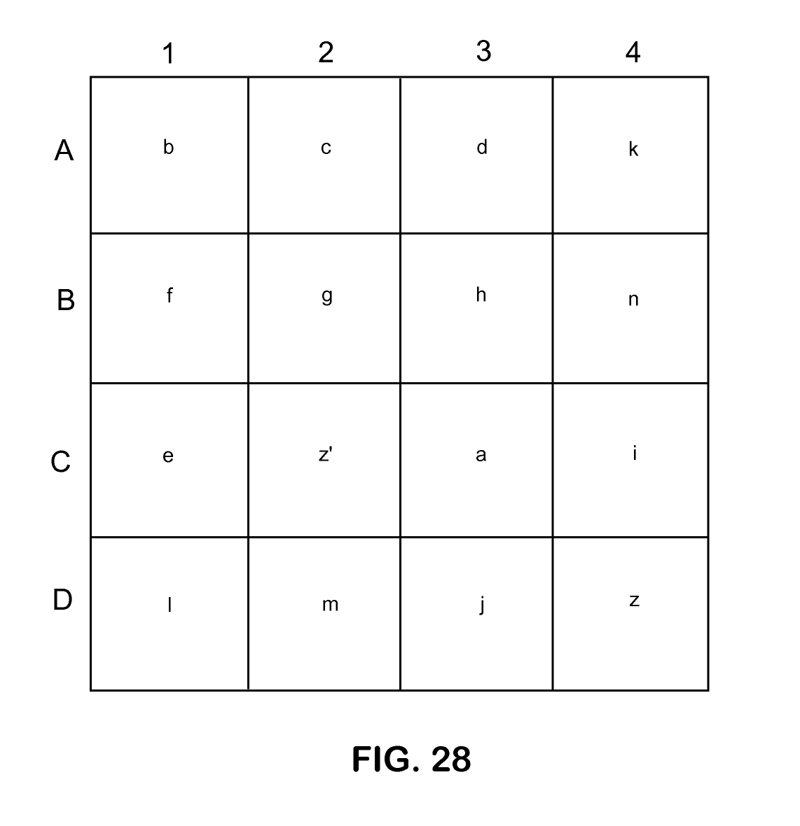

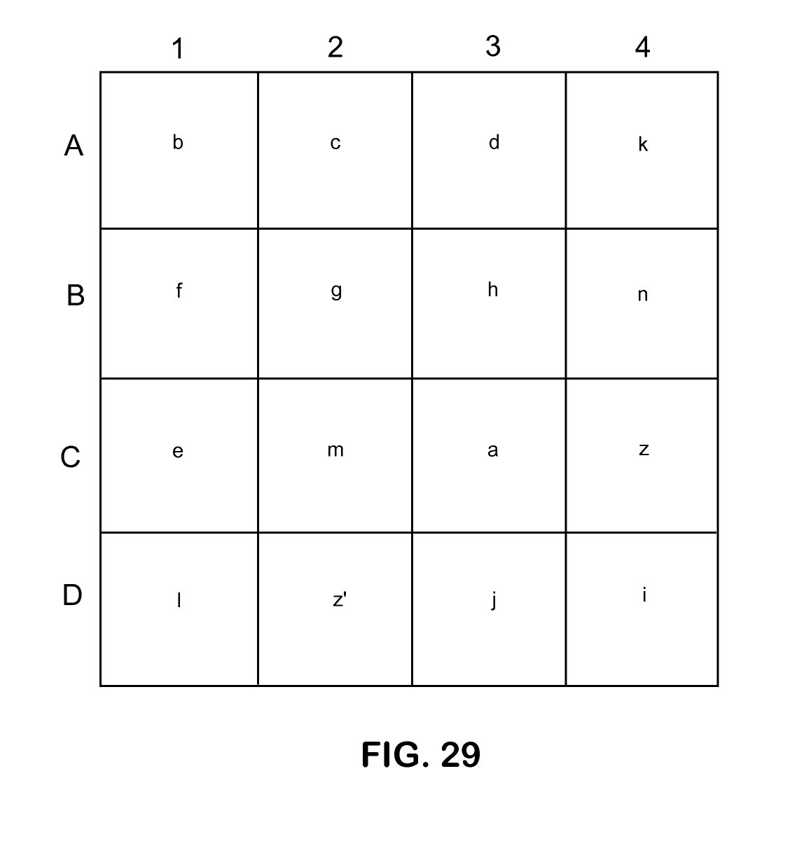

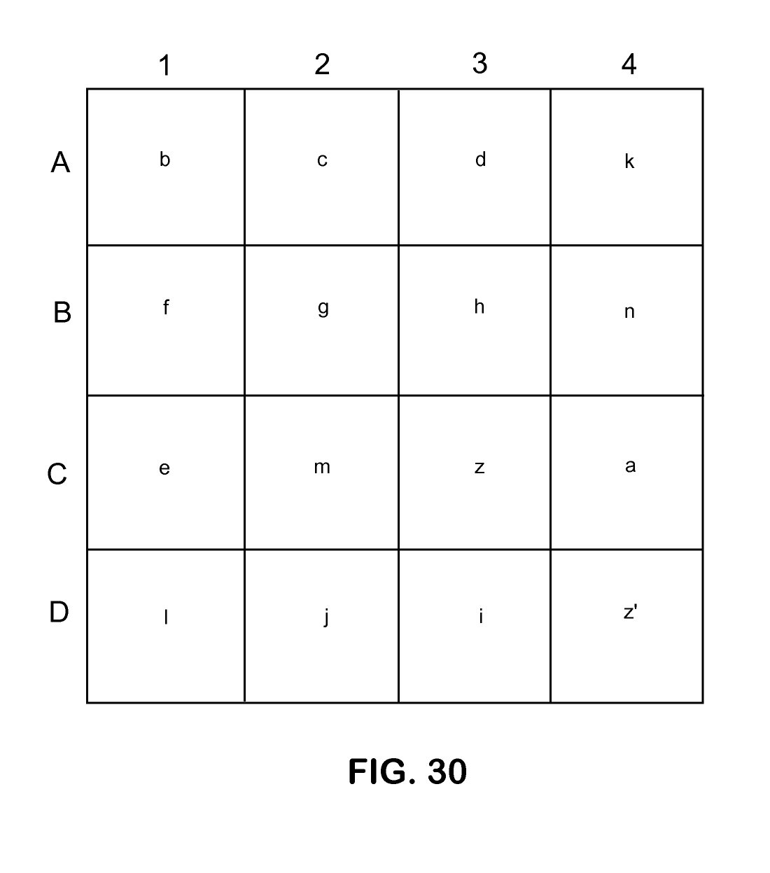

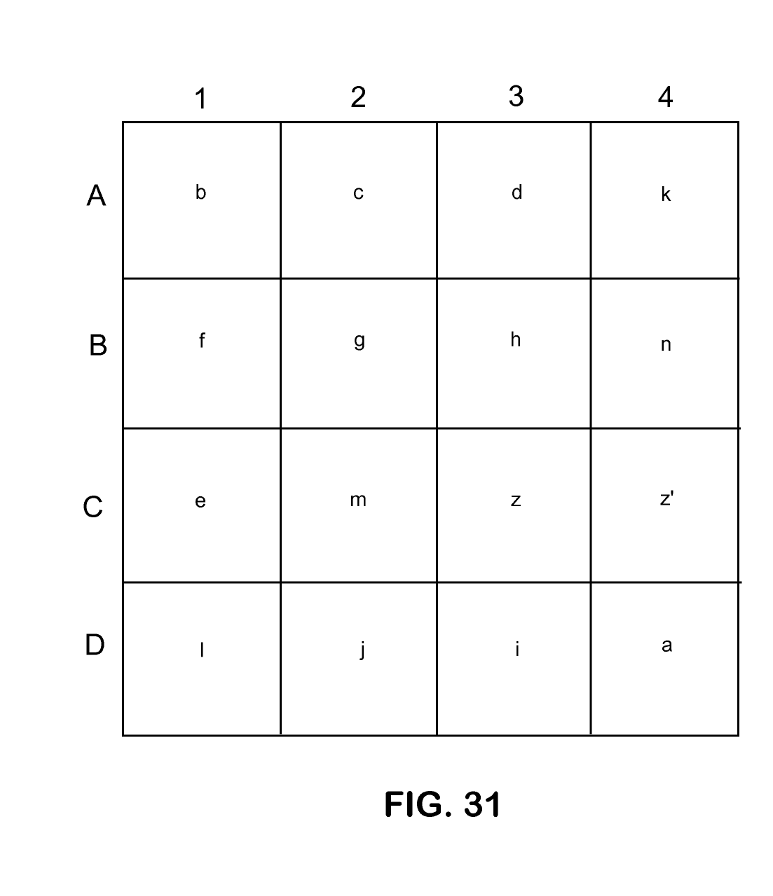

Another way to reduce the access time is to use more space for empty locations. For example, consider the configuration is FIGS. 20-31. In this example, the storage space is divided into 16 container positions (4×4). At any given time, instead of one container position being empty, two container positions are empty. In order move container “a” from A1 to the access position D4, 12 shifts are required instead of 21 as shown in FIG. 20-31 and represented by the following table:

| A | A | A | A | B | B | B | B | C | C | C | C | D | D | D | D | |
|---|---|---|---|---|---|---|---|---|---|---|---|---|---|---|---|---|
| 1 | 2 | 3 | 4 | 1 | 2 | 3 | 4 | 1 | 2 | 3 | 4 | 1 | 2 | 3 | 4 | |
| a | b | c | d | e | f | g | h | i | j | k | | l | m | n | | FIG. 20 |
| a | b | c | d | e | f | g | h | | i | j | k | | l | m | n | FIG. 21 |
| | b | c | d | | f | g | h | a | i | j | k | e | l | m | n | FIG. 22 |
| b | c | d | | f | g | h | | a | i | j | k | e | l | m | n | FIG. 23 |
| b | c | d | k | f | g | h | n | a | i | j | | e | l | m | | FIG. 24 |
| b | c | d | k | f | g | h | n | | a | i | j | | e | l | m | FIG. 25 |
| b | c | d | k | f | g | h | n | | a | i | j | e | l | m | | FIG. 26 |
| b | c | d | k | f | g | h | n | e | a | i | | | l | m | j | FIG. 27 |
| b | c | d | k | f | g | h | n | e | | a | i | l | m | j | | FIG. 28 |
| b | c | d | k | f | g | h | n | e | m | a | | l | | j | i | FIG. 29 |
| b | c | d | k | f | g | h | n | e | m | | a | l | j | i | | FIG. 30 |
| b | c | d | k | f | g | h | n | e | m | | | l | j | i | a | FIG. 31 |

Therefore, the average number of shifts for accessing any randomly selected container would be 6 instead of 11. The extra spaces help significantly in larger grids. For example, in the 10 by 10 grid, normally the worst case number of shifts required is 69. In this configuration, 99 spaces are occupied by containers results in a 99% efficient storage area. By adding one extra empty space, the worst case access reduces to 44 while only reducing the storage efficiency by an additional 1% to 98%. By adding three extra spaces, the worst case access reduces to 22 with an average access of 11 shifts with a storage efficiency of 96%.

As discussed above, in some embodiments, multiple access locations permit more than one object 20 to be accessed. For instance, in the example of FIGS. 20-31, assume “a” second access position is located at D3. If the owner of container i needs access, by luck, that container is already in position. If not, the other containers are shifted without moving container a. For example, if the second user owns container m, then the following additional shifts are performed (note that container a remains in the D4 position):

| A | A | A | A | B | B | B | B | C | C | C | C | D | D | D | D | |
|---|---|---|---|---|---|---|---|---|---|---|---|---|---|---|---|---|
| 1 | 2 | 3 | 4 | 1 | 2 | 3 | 4 | 1 | 2 | 3 | 4 | 1 | 2 | 3 | 4 | |
| b | c | d | k | f | g | h | n | e | m | | | l | j | i | a | FIG. 31 |
| b | c | d | k | f | g | h | n | | e | m | | l | j | i | a | |
| b | c | d | k | f | g | h | n | l | e | m | | | j | i | a | |
| b | c | d | k | f | g | h | n | l | e | m | | j | i | | a | |
| b | c | d | k | f | g | h | n | l | e | | | j | i | m | a | m is in D3 |

Note that the above shifts require partial row/columns shifts and need mechanisms of the embodiments whereby a subset of the containers 20 of one row or one column can shift independently of other containers 20 in that row/column. For example, moving j,i left on column as above is done by mechanisms that shift the D2,D3 coordinates left one position without shifting the D4 position left, being that D4 contains the container 20 a being accessed by the first user.

It is anticipated that in some embodiments, an external door be provided at each access point to shield the users from coming into contact with the shifting containers 20.

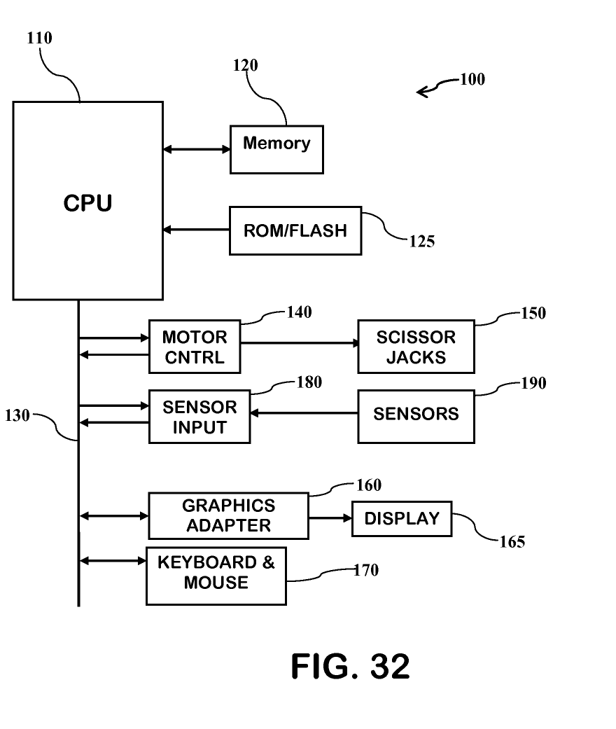

Referring to FIG. 32, a typical computer system is shown. A processor 110 is provided to execute stored programs that are generally stored for execution within a memory 120. Generally, such computer systems are often referred to as controllers, programmable logic controllers (PLC) and the like. The processor 110 can be any processor or a group of processors, for example an Intel Pentium-4® CPU or the like. The memory 120 is connected to the processor and can be any memory suitable for connection with the selected processor 110, such as SRAM, DRAM, SDRAM, RDRAM, DDR, DDR-2, etc. Firmware is stored in firmware storage 125 that is connected to the processor 110 and may include initialization software. The firmware storage 125 is any known persistent storage including ROM, Flash, PROM, EPROM, EEPROM and battery-backed-up RAM.

Also connected to the processor 110 is a system bus 130 for connecting to peripheral subsystems such as motor controls 140, sensor inputs 180, a graphics adapter 160 and a keyboard/mouse 170. The graphics adapter 160 receives commands and display information from the system bus 130 and generates a display image that is displayed on the display 165. The keyboard and mouse 170 are used to accept operator inputs for control of the system.

In general, the motor control 140 interfaces to the motor drive system 150. There are many known ways to control the motors that move the containers 20 around the grid, including servo motors and free running motors with feedback sensors. In many embodiments, sensors are positioned around the grid to sense, for example, the position of the containers 20 within the grid 16/18. The sensors 190 are connected to sensor input ports 180 and are any known type of sensor including electric eyes, micro-switches, proximity switches and the like.

The firmware 125 includes software algorithms that remember which container is in which position within the grid and, when requested, controls the motor system to shift the containers around the grid in order to move the target container to a target access location. In some embodiments, the firmware 125 keeps track of the location of each object (frame, container, etc.) as it moves from one position to the next. Additionally, in some embodiments, sensors are provided to determine the identity of any given object (frame, container, etc.) by reading a bar code, RFID or other device affixed to the object (frame, container, etc.).

Referring now to FIG. 33, an isometric view of the present invention with framed containers is shown. As previously stated, the present invention provides for storage, relocation and access of any objects. In some embodiments, as previously shown, the objects to be stored and accessed (e.g., parts, household goods, furniture and the like) are held within containers. In some embodiments, the objects are not held in a container having walls, per se. Instead, either the objects themselves are suitable for moving within the storage system of the present invention (e.g., 55 gallon drums, soda cans, etc) or the objects are supported by a flat, palette or frame as they are stored, relocated and accessed.

FIG. 33 shows an example of a frame 220 for supporting various objects. In this example, the frame 220 supports palettes 232 and, several boxes 230 are positioned upon the palettes 232. In some embodiments, the frame 220 has three walls and is open in front (as shown) while in other embodiments, the frame 220 has only two walls or no walls. In the embodiment shown in FIG. 33, the frame has three walls for supporting additional levels of frames atop the walls. In some embodiments, registration devices 222 fit into holes (not shown) on the bottom of successive frames to keep the frames stacked correctly. In some stacked embodiments, the bottom layers of frames 220 have walls and is some embodiments, the top layer of frames is without walls.

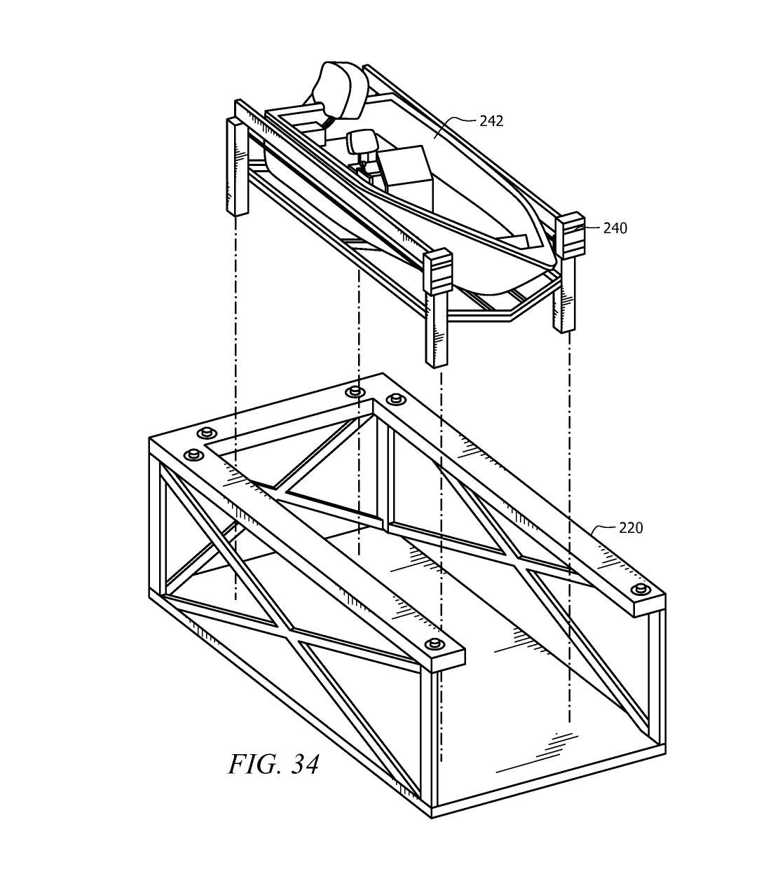

Referring now to FIG. 34, an isometric view of the present invention with framed containers and stands is shown. In some embodiments, the objects are not stable by themselves and would fall or be damaged as they are shifted about the storage facility. For such objects, a rack such as the boat rack 240 or a sling (not shown) is provided for support, protection and stability. In this example, a boat 242 is supported by a rack 240 and the rack is held on or within the frame 220 during storage. This embodiment of the present invention is effective for high and dry storage. The present technology for high and dry boat storage is multiple levels of storage locations that accept a boat in a sling. When a boat is stored, it is lifted by a fork lift and placed in one of the storage locations. In such, a large amount of building space is devoted to access rows and wide enough for the fork lift carrying the boat. There needs to be enough space to maneuver and store or access the largest boat. Using the present invention, minimal space is wasted because every location except for the access location is capable of storing a boat. Furthermore, efficient space utilization is possible since access time is not critical for such situations as boat storage.

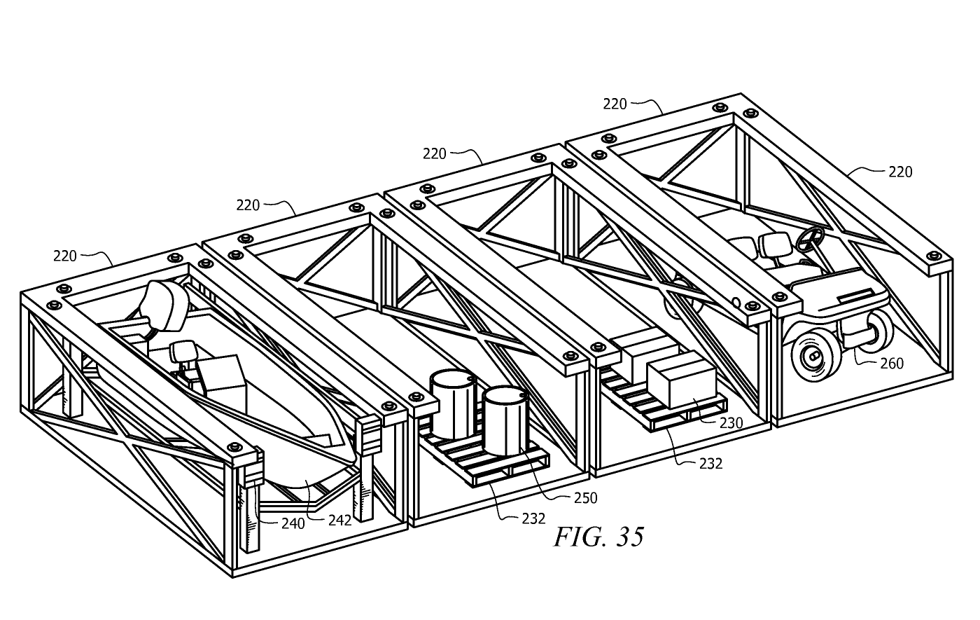

Referring now to FIG. 35, an isometric view of the present invention with framed containers holding various objects is shown. In this example, multiple frames 220 are shown within the storage area. This is just an example of a partial area of storage and for simplicity, the building walls, shifting mechanisms and access facility is not shown but is as previously described. Each of the frames 220 hold various objects including a boat 242 in a rack 240; several 55 gallon drums 250 on a palette 232; several boxes 230 on another palette 232 and a vehicle 260. This exemplifies the variety of objects that are supported by the present invention.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An efficient storage system comprising:
a plurality of objects, the objects moveably organized within a building, the building organized as a grid of storage positions in rows and columns, each storage position sized to hold one of the objects,
at least one empty storage position within the grid, the at least one empty storage position adapted to allow shifting of the objects within the grid;
at least one access location, the at least one access location configured to provide access to the objects; and
a means for moving the objects within the grid, the means for moving the objects within the grid adapted to shift a target object from a current storage position in the grid to one of the at least one access location.

2. The efficient storage system of claim 1, wherein the at least one empty storage position is exactly one empty storage position.

3. The efficient storage system of claim 1, wherein the means for moving the objects includes scissor jacks positioned at the ends of the rows and the columns.

4. The efficient storage system of claim 1, wherein additional objects are stacked on top of each of the plurality of objects.

5. The efficient storage system of claim 4, further comprising at least one lift situated at the access location and the at least one lift is adapted to access the additional objects that are stacked on top of each of the plurality of objects.

6. The efficient storage system of claim 4, further comprising at least one elevator situated at the access location adapted to lower and raise the additional containers thereby providing access to the target container at ground level.

7. The efficient storage system of claim 1, wherein the objects are moveably organized within the building on ball and socket gliders.

8. The efficient storage system of claim 7, wherein the objects are on frames and a bottom surface of the frames has grooves in which the balls of the ball and socket gliders travel, thereby keeping the frames aligned within the grid.

9. The efficient storage system of claim 1, wherein the objects are on frames and a bottom surface of the frames have retractable wheels for moving the frames within the grid.

10. A method of efficiently storing objects, the objects stored on a frame, the method comprising:
organizing the frames within a building, each frame at a storage location of a grid within the building, the frames slideable from one storage location within the grid to a neighboring storage location within the grid, the grid having at least one empty storage location within the grid;
determining a target frame; and
sequentially shifting the frames within the grid until the target frame reaches an access location.

11. The method of claim 10, wherein the frames have at least two sides.

12. The method of claim 10, further comprising racks situated on the frames for stably holding the objects.

13. The method of claim 10, wherein the sequentially shifting includes moving at least one of the frames into one of the at least one empty storage position, thereby moving the one of the at least one empty storage position to a new position within the grid.

14. The method of claim 10, wherein the grid comprises X rows and Y columns and a total number of possible storage locations in the grid equals X times Y and a total number of empty storage locations within the grid is Z, therefore, a measurement of storage efficiency is represented as: ((X*Y)−Z)/(X*Y).

15. The method of claim 12, wherein the grid comprises 10 rows, 10 columns and the total number of empty storage locations in the grid is one and the storage efficiency is ((10*10)−1/(10*10), or 99%.

16. An efficient storage system comprising:
a plurality of means for storing objects, each of the means for storing objects adapted to hold one or more objects;
a grid of storage positions, the grid organized in rows and columns, each storage position sized to hold at least one of the means for storing objects, wherein at least one of the storage positions is empty, thereby at least one of the means for storing objects is shiftable from one of the storage positions to the at least one empty storage positions;
at least one access location adapted to load and unload the plurality of means for storing objects; and
a means for moving each of the plurality of means for storing objects within the grid.

17. The efficient storage system of claim 16, wherein exactly one of the storage positions is empty.

18. The efficient storage system of claim 16, wherein the means for storing objects is a container.

19. The efficient storage system of claim 16, wherein the means for storing objects is a frame.

20. The efficient storage system of claim 19, wherein multiple frames are stacked and at least one lift is situated at the access location providing access to objects within the frames that are stacked.

21. The efficient storage system of claim 19, wherein multiple frames are stacked and at least one elevator is situated at the access location providing access to the frames that are stacked by lowering the frames that are stacked into a basement substructure thereby providing access to objects in a target frame at a ground level.

22. The efficient storage system of claim 19, further comprising a rack situated on the frame for holding the objects.

23. The efficient storage system of claim 22, wherein the rack is configured to hold a boat.
